(19) United States
(12) Patent Application Publication
(10) Pub. No.: US 2026/0233947 A1
(43) Pub. Date: Aug. 13, 2026

(54) GRIPPING DEVICE AND CONVEYANCE METHOD

(71) Applicant: Konica Minolta, Inc., Tokyo (JP)

(72) Inventor: Yusuke MURAKAMI, Tokyo (JP)

(21) Appl. No.: 19/529,889

(22) Filed: Feb. 4, 2026

(30) Foreign Application Priority Data
Feb. 7, 2025 (JP) 2025-018964

(51) Int. Cl. B65G 47/90

(52) U.S. Cl. CPC B65G 47/90

(57) ABSTRACT

A gripping device is a gripping device that grips a conveyed material composed of one or more sheet-shaped members, and includes a base section and a gripper disposed on the base section and capable of gripping the conveyed material so as to curve the conveyed material.

### CROSS REFERENCE TO RELATED APPLICATIONS

The entire disclosure of Japanese patent Application No.2025 -018964, filed on Feb. 7, 2025, is incorporated herein by reference in its entirety.

### BACKGROUND

### Technological Field

The present invention relates to a gripping device and a conveyance method.

### Description of Related Art

Conventionally, a technique is known in which a conveyed material formed of a sheet-shaped member, such as a printed material, is conveyed to a predetermined place using a gripping device provided in a robot apparatus. For example, Japanese Unexamined Patent Publication No. 2021-154408 No. discloses a configuration in which a conveyed material can be held between a horizontal portion (lower holding portion) for supporting the conveyance from below and a flat plate-shaped upper holding portion for pressing the conveyance on the horizontal portion.

Furthermore, in a case where a conveyed material is conveyed using a general robot apparatus, it is known that after the conveyed material is gripped, conveyance (vertical conveyance) is performed in a state where a tip end portion (an end portion opposite to the gripped portion) of the conveyed material faces downward.

### SUMMARY

Note that depending on the shipping destination (store, end user, or the like) of printed material, a combination of a plurality of printed materials or the like output from a plurality of printing machines or a product obtained by processing predetermined printed material may be shipped as a shipment. In this case, it is necessary to accurately place the conveyed material at a predetermined position of the predetermined place. When an operator performs such work, there is a possibility that a loss occurs due to an injury of the operator, a work mistake, or the like, and productivity decreases. Therefore, it is required to automate the work of conveying the conveyed material described above by using a robot apparatus.

However, since a conveyed material is conveyed by vertical conveyance in a general robot apparatus, it is difficult to place the conveyed material in a horizontal posture. Therefore, there is a possibility that the conveyed material cannot be placed at a predetermined position with high accuracy.

In addition, the configuration described in Japanese Unexamined Patent Publication No. 2021-154408 is capable of conveyance of the conveyed material in a horizontal posture, but a mechanism for gripping the conveyed material is increased in size. Therefore, in an ejection section of a printing machine or the like which is not assumed to be approached by the robot apparatus, the robot apparatus or the gripping device interferes with the machine such as the printing machine when the gripping device grips the conveyed material and releases the gripping. Although it is possible to avoid the above-described interference by increasing the size of the ejection section or the like of the conveyance destination, there is a concern that an increase in the size of the entire system and an increase in cost may be caused. In addition, since the orientation of the conveyed material gripped by the gripping device is uniquely determined, it may not be possible to cope with the situation depending on the orientation of the conveyed material at the time of gripping or the orientation of the conveyed material at the conveyance destination.

That is, it has been difficult to automate work of conveying a conveyed material that is formed of a sheet-shaped member with the conventional technology.

Objectives of the present invention include providing a gripping device and a conveying method capable of automating a conveying operation of a conveyed material formed of a sheet-shaped member.

In order to achieve at least one of the above-described objectives, a gripping device reflecting one aspect of the present invention is a gripping device for gripping a conveyed material including one or more sheet-shaped members, the gripping device including:

a base section; and

a gripper disposed on the base section and capable of gripping the conveyed material so as to curve the conveyed material.

In order to realize at least one of the above-described objectives, a conveying method reflecting one aspect of the present invention is a conveying method performed by a gripping device including a base section and a gripper disposed on the base section and capable of gripping a conveyed material composed of one or more sheet-shaped members, and includes:

gripping the conveyed material by the gripper; and

conveying the conveyed material gripped by the gripper, in which

the gripping includes gripping the conveyed material by the gripper so as to curve the conveyed material.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A is a diagram illustrating a combination system according to an embodiment of the present invention;

FIG. 1B is a diagram illustrating the combination system according to the present embodiment;

FIG. 2 is a diagram illustrating the combination system according to the present embodiment;

FIG. 3A is a front view of a hand section;

FIG. 3B is a view of the hand section from the Z direction;

FIG. 4 is a diagram illustrating a state of the curve of the conveyed material;

FIG. 5A is a diagram for explaining an operation of a gripper performed when gripping a conveyed material;

FIG. 5B is a diagram for explaining an operation of the gripper performed when gripping a conveyed material;

FIG. 6A is a diagram for explaining an operation of the gripper performed when the conveyed material is placed;

FIG. 6B is a diagram for explaining an operation of the gripper performed when the conveyed material is placed;

FIG. 7 is a diagram for explaining an operation of the gripper performed when the conveyed material is placed;

FIG. 8 is a diagram for explaining an operation of the gripper performed when the conveyed material is placed;

FIG. 9 is a flowchart showing an operation example of conveyance processing by the robot apparatus;

FIG. 10 is a diagram illustrating a configuration of a gripper according to a variation; and

FIG. 11 is a diagram illustrating a configuration of a gripper according to a variation.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the drawings.

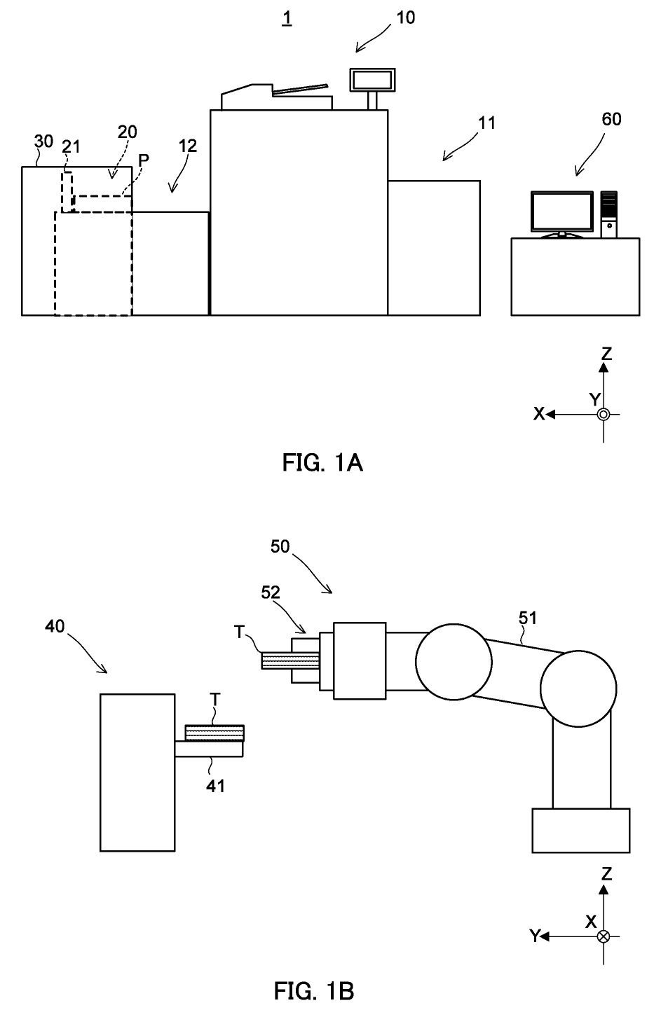

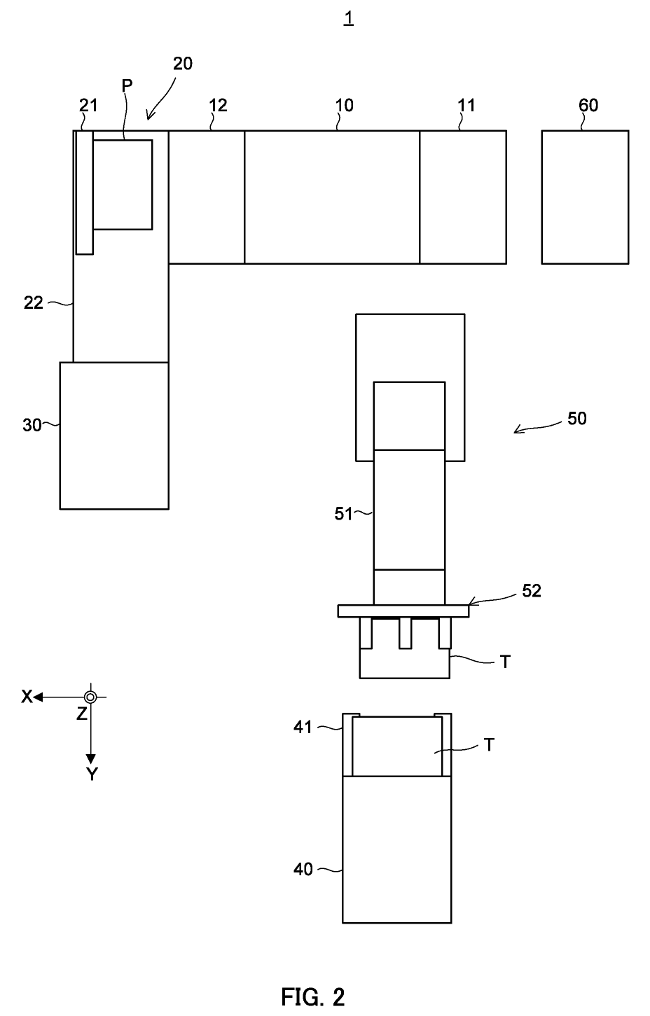

As illustrated in FIGS. 1A, 1B, and 2, the combination system 1 is a system that can convey a predetermined conveyed material T to the placement location of a predetermined printed material P by using a robot apparatus 50, and combine these into one.

The combination system 1 includes an image forming apparatus 10, a stacking apparatus 20, a post-processing device 30, a loading apparatus 40, a robot apparatus 50, and a control apparatus 60. Note that in the present embodiment, description will be given using an orthogonal coordinate system (X, Y, Z). In the following description, it is assumed that an X direction is a conveyance direction of a sheet-shaped member of the image forming apparatus 10, a Y direction is a conveyance direction of a printed material from the stacking apparatus 20 to the post-processing device 30, and a Z direction is an up-down direction.

The image forming apparatus 10 is a printing machine capable of forming an image on a sheet-shaped member. The sheet feed section 11 is disposed on the − side in the X direction of the image forming apparatus 10, and the ejection section 12 is disposed on the + side in the X direction of the image forming apparatus 10. The image forming apparatus 10 forms an image on a sheet-shaped member fed from the sheet feed section 11, and ejects the sheet-shaped member (printed material P) to the stacking apparatus 20 via the ejection section 12. The image forming apparatus 10 can communicate with the control apparatus 60, and performs print processing based on a print job received via the control apparatus 60.

Note that the ejection section 12 is provided with a mechanism for delivering the ejected sheet-shaped member to the stacking apparatus 20, so that the sheet-shaped member subjected to print processing based on a print job is delivered to the stacking apparatus 20 from the image forming apparatus 10.

The stacking apparatus 20 is an apparatus capable of conveyance of the printed material P ejected from the image forming apparatus 10 to the post-processing device 30. The stacking apparatus 20 includes an abutting section 21 and a conveyor section 22.

The abutting section 21 is a portion against which the sheet-shaped member ejected from the image forming apparatus 10 is abutted, and is provided at a downstream end portion (a + side end portion in the X direction) of the ejection section 12 of the image forming apparatus 10.

The distal end portion of the sheet-shaped member ejected from the image forming apparatus 10 is abutted against the abutting section 21, and the sheet-shaped member is disposed in a state where the distal end portion is in contact with the abutting section 21. In a case where another sheet-shaped member has already been placed at the position corresponding to the abutting section 21, the sheet-shaped member is placed so as to be loaded on the other sheet. Therefore, when printing of a plurality of copies is performed, a bundle (printed material P) constituted by a plurality of sheet-shaped members is disposed at a position corresponding to the abutting section 21 in the ejection section 12.

The conveyor section 22 is a portion for conveyance of the printed material P disposed at the position of the abutting section 21 to the post-processing device 30, and for example, conveys the sheet-shaped member in a direction toward the + side of the Y direction orthogonal to the direction (the X direction) in which the sheet-shaped member is ejected.

The sheet-shaped member ejected from the image forming apparatus 10 is, for example, oriented such that the short sides are along the X direction (ejection direction) and the long sides are along the Y direction. The conveyor section 22 is disposed such that the sheet-shaped member can be conveyed toward the post-processing device 30 (the + side in the Y direction) while keeping the orientation in the state where the sheet-shaped member has been ejected.

The post-processing device 30 is a post-printing processing machine for performing post-processing on a bundle of sheet-shaped members (printed material P) or the like printed by the image forming apparatus 10, and is, for example, a banding machine. Specifically, the post-processing device 30 performs a banding process on the printed material P constituted by one or more sheet-shaped members conveyed from the stacking apparatus 20 to bundle the printed material P, and ejects the printed material P to the outside of the apparatus. As a result, the printed material P is ready for shipment.

The loading apparatus 40 is a device (e.g., a shelf) that loads a predetermined conveyed material T. The predetermined conveyed material T is constituted by a printed material printed by a printing machine different from the image forming apparatus 10 and/or one or more sheet-shaped members processed by another post-printing processing machine or the like. The loading apparatus 40 can load a plurality of sets of conveyed materials T, and has a handling mechanism (not illustrated) for taking out the conveyed materials T one set at a time.

For example, in the loading apparatus 40, one set is placed at a time in the take-out section 41 by the handling mechanism from a portion where a plurality of sets of conveyed materials T are loaded on one another. The conveyed materials T disposed in the take-out portion 41 are conveyed to the ejection section 12 of the image forming apparatus 10 by the robot apparatus 50.

Furthermore, the take-out section 41 has, for example, a configuration capable of supporting both width direction end portions of the conveyed material. In the configuration illustrated in FIGS. 1B and 2, the take-out section 41 is configured to support only both ends of the conveyed material T in the width direction (X direction).

The robot apparatus 50 is a device that can convey the conveyed materials T placed on the take-out section 41 of the loading apparatus 40 to a predetermined conveyance destination. The predetermined conveyance destination may be, for example, the abutting section 21 of the stacking apparatus 20. In this case, the robot apparatus 50 is movable at least between the loading apparatus 40 and the stacking apparatus 20, and can convey the conveyed material T to the stacking apparatus 20 and merge it with the printed material P placed at the position of the abutting section 21.

The robot apparatus 50 is, for example, a robot apparatus imitating a human hand, and has a function to grip a conveyed material T on a loading apparatus 40 and convey the conveyed material T to a predetermined conveyance destination. The robot apparatus 50 includes an arm section 51 and a hand section 52.

The arm section 51 is, for example, a robot arm such as a vertical articulated robot or a SCARA robot, and has a proximal end fixed to a stage or the like and a distal end connected to the hand section 52 capable of gripping a conveyed material. The arm section 51 is configured to be able to move the hand section 52 in all directions, such as up, down, left, right, front, and back.

The hand section 52 is a portion for gripping the conveyed material T. The hand section 52 is attached to the arm section 51, and is configured to be able to perform a gripping operation by a drive mechanism (not illustrated) to which torque is transmitted from an actuator or the like. A detailed configuration of the hand section 52 will be described later.

The control apparatus 60 is a device (e.g., a Personal Computer (PC), a portable terminal, or the like) communicable with the combination system 1 including the image forming apparatus 10 and the robot apparatus 50. The control apparatus 60 includes a Central Processing Unit (CPU), a Read Only Memory (ROM), a Random Access Memory (RAM), and an input/output circuit, which are not illustrated. The control apparatus 60 transmits control signals to the arm section 51 and the hand section 52 to control the operation of the arm section 51 and the hand section 52.

Specifically, the control apparatus 60 controls the hand section 52 so as to grip the conveyed material T disposed on the take-out section 41 of the loading apparatus 40. Next, the control apparatus 60 controls the arm section 51 so that the hand section 52 gripping the conveyed material T is located at a position corresponding to the abutting section 21 (predetermined conveyance destination) of the stacking apparatus 20. Then, the control apparatus 60 releases the gripping by the hand section 52 and places the conveyed material T in the stacking apparatus 20.

For example, the control apparatus 60 may execute a predetermined print job by transmitting a control signal to the image forming apparatus 10 in parallel with the operation of the arm section 51 and the hand section 52. The predetermined print job is, for example, a job for printing of the printed material P to be combined with the conveyed material T placed on the loading apparatus 40 to form one set of shipping product (product).

After one set of the printed material P in the print job is ejected, the control apparatus 60 may perform control so as to release the gripping by the hand section 52 and place the conveyed material T on the printed material P. Thus, the printed material P ejected from the image forming apparatus 10 and the conveyed material T of the loading apparatus 40 can be easily combined.

Further, after placing the conveyed material T in the stacking apparatus 20, the control apparatus 60 controls the stacking apparatus 20 to convey a combined material being a combination of the conveyed materials T or the printed materials P toward the post-processing device 30. Next, the control apparatus 60 controls the post-processing device 30 to load the conveyed material or the like into the post-processing device 30, perform post-processing on the combined material or the like, and then eject the combined material or the like from the post-processing device 30. In this way, the conveyed material T or the combined material before the post-processing can be easily conveyed to a supply portion of the post-processing device 30.

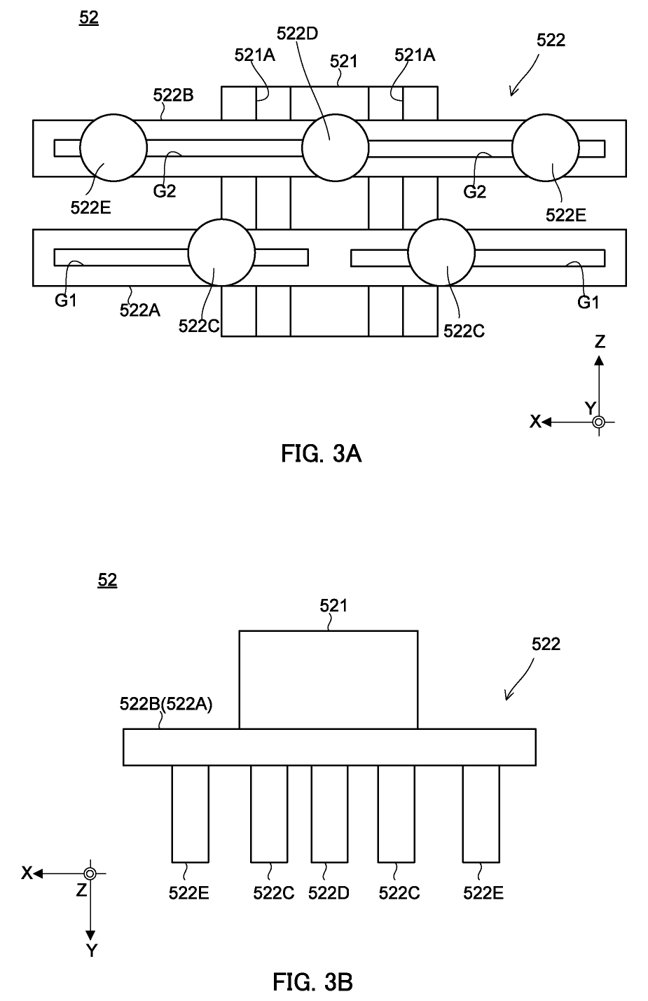

Next, a detailed configuration of the hand section 52 of the robot apparatus 50 will be described. FIG. 3A is a view of the hand section 52 as viewed from the front (the + side in the Y direction). FIG. 3B is a view of the hand section 52 as viewed from the Z direction. Note that the hand section 52 of the robot apparatus 50 is illustrated in FIGS. 3A and 3B in the same orientation as in FIGS. 1B and 2.

As illustrated in FIGS. 3A and 3B, the hand section 52 is configured to be able to grip the conveyed material T so that the conveyed material T can be conveyed in a horizontal state (horizontal conveyance). The hand section 52 includes a base section 521 and a gripper 522. The hand section 52 corresponds to a "gripping device" according to the present invention.

The base section 521 is a portion attached to the distal end of the arm section 51. Further, the base section 521 has the rails 521A extending in the gripping direction of the gripper 522, and supports the gripper 522 via the rails 521A.

The gripping direction of the gripper 522 is a direction in which a first support portion 522A and a second support portion 522B, which will be described later, move when gripping (sandwiching) the conveyed material T. The gripping direction is the Z direction in a case where the posture of the hand section 52 is the posture during horizontal conveyance.

The gripper 522 is a portion that grips the conveyed material T, and includes a first support portion 522A, a second support portion 522B, a pair of first pressers 522C, a second presser 522D, and a pair of restricting portions 522E.

The first support portion 522A and the second support portion 522B are supported by the rails 521A of the base section 521, and are configured to be movable in the gripping direction (Z direction) along the rails 521A.

The first support portion 522A is disposed further to the − side in the Z-direction than the second support portion 522B and supports the pair of first pressers 522C. The first support portion 522A is configured to extend in a width direction of the conveyed material T (the X direction in FIG. 3A and the like). The first support portion 522A is provided with grooves G1 extending in the width direction. Two grooves G1 are provided side by side in the width direction in the first support portion 522A.

The second support portion 522B is disposed on the + side in the Z direction relative to the first support portion 522A, and supports the second presser 522D and the pair of restricting portions 522E. The second support portion 522B is configured to extend in a width direction of the conveyed material T (the X direction in FIG. 3A and the like). The second support portion 522B is provided with grooves G2 extending in the width direction. Two grooves G2 are provided side by side in the width direction in the second support portion 522B.

The pair of first pressers 522C are portions that can press the conveyed material from one side in the Z direction (one side in the gripping direction). The pair of first pressers 522C are supported so as to be movable in the width direction of the conveyed material T in the two grooves 522A of the first support portion G1, respectively.

Each of the pair of first pressers 522C is formed of a rod-shaped member having a circular arc-shaped peripheral surface, and is provided so as to protrude from the first support portion 522A in the Y direction. That is, the pair of first pressers 522C is provided so as to extend from the base section 521 via the first support portion 522A.

The second presser 522D is a portion that can press the conveyed material from the + side in the Z direction (the other side in the gripping direction), and is supported by a central portion of the second support portion 522B in the width direction of the conveyed material (the X direction in FIG. 3A and the like). That is, the second presser 522D is disposed at a position corresponding to a position between the pair of first pressers 522C in the width direction.

Similarly to the first presser 522D, the second presser 522C is formed of a rod-shaped member having a circular arc-shaped peripheral surface, and is provided so as to protrude from the second support portion 522B in the Y direction. That is, the second presser 522D is provided so as to extend from the base section 521 via the second support portion 522B.

When the conveyed material T is gripped by the gripper 522, the conveyed material T is pressed from the − side in the Z direction by the pair of first pressers 522C, and is pressed from the + side in the Z direction by the second presser 522D.

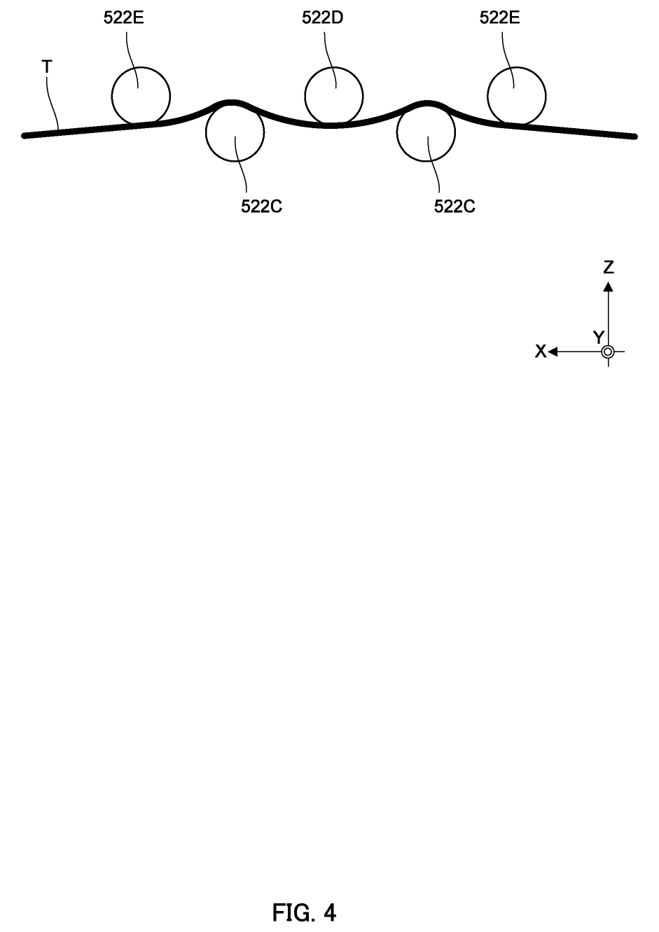

Accordingly, as shown in FIG. 4, the conveyed material T is curved such that the surface on the − side in the Z direction of the portion of the conveyed material T pressed by the second presser 522D is positioned on the − side in the Z direction with respect to the contact portion between the first presser 522C and the conveyed material. That is, the gripper 522 grips the conveyed material T so as to curve the conveyed material T.

The state in which "the conveyed material T is gripped so as to curve the conveyed material T" referred to herein includes a state in which the conveyed material T is gripped by the gripper 522 in a state where a curved portion is formed in the conveyed material T as well as a state in which the conveyed material T is gripped by the gripper 522 in a state where the conveyed material T does not have a curved portion. The state in which the conveyed material T is gripped by the gripper 522 without a curved portion includes a state in which the conveyed material T is gripped by the gripper 522 with an angular portion formed thereon. In addition, for example, in a case where the conveyed material T is formed of a sufficiently stacked sheet-shaped member or in a case where the sheet-shaped member forming the conveyed material T has high rigidity such as thick paper, the conveyed material gripped by the gripper 522 may not be curved. The state in this case is also included in the state of being gripped by the gripper 522 without having a curved portion.

As shown in FIGS. 3A and 3B, the pair of restricting portions 522E is a portion for restricting the posture of the conveyed material gripped by the gripper 522. The pair of restricting portions 522E are supported respectively in the two grooves 522B of the second support portion G2 so as to be movable in the width direction of the conveyed material T.

Each of the pair of restricting portions 522E is formed of a rod-shaped member having a circular arc-shaped peripheral surface, and is provided so as to protrude from the second support portion 522B in the Y direction.

As shown in FIG. 4, since the conveyed material T gripped by the gripper 522 is pressed and curved by the pair of first presser 522C and the second presser 522D, both end portions of the conveyed material T in the width direction are directed to the + side in the Z direction. Therefore, the posture of the conveyed material T is restricted by the pair of restricting portions 522E and so as to press the both end portions from the + side in the Z direction outside the pair of first pressers 522C.

The presence or absence of gripping of the conveyed material T by the gripper 522 may be detected by, for example, a sensor that can be provided in the gripper 522. It is sufficient that the sensor can detect a reaction force that the gripper 522 receives from the conveyed material T when the conveyed material T is gripped.

Accordingly, it is possible to detect the thickness or the like of the conveyed material T in addition to the presence or absence of the gripping of the conveyed material T.

Next, a gripping operation of the conveyed material by the hand section 52 will be described.

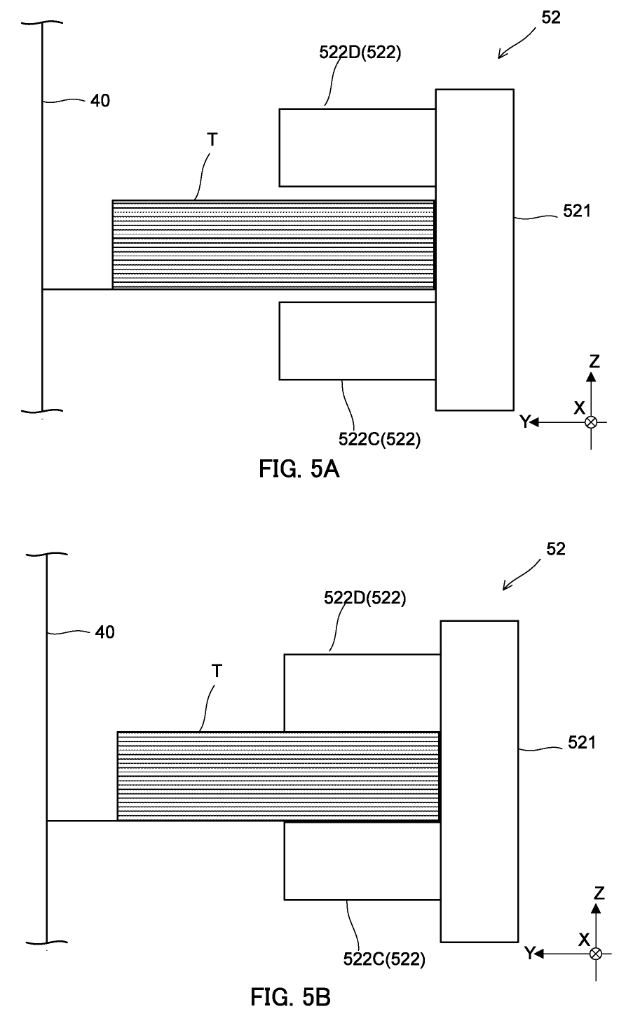

First, as shown in FIG. 5A, the control apparatus 60 widens the distance between the first support portion 522A and the second support portion 522B to such an extent that the conveyed material T can enter between the first support portion 522A and the second support portion 522B of the hand section 52. Then, the control apparatus 60 moves the hand section 52 to the position of the loading apparatus 40.

Further, the control apparatus 60 adjusts the distance between the pair of first pressers 522C in the width direction and the distance between the pair of restricting portions 522E in the width direction in accordance with the widths of the conveyed materials T loaded on the loading apparatus 40.

In this case, the distance between the pair of first pressers 522C in the width direction and the distance between the pair of restricting portions 522E in the width direction are adjusted such that the restricting portions 522E are located closer to the end portions of the conveyed material T than the first presser 522C in the width direction of the conveyed material T. In addition, the pair of first pressers 522C may be able to be disposed in the vicinity of the end portions of the conveyed material T depending on the width of the conveyed material T, for example, when the conveyed material T is too narrow. In such a case, the distance between the pair of first pressers 522C in the width direction and the distance between the pair of restricting portions 522E in the width direction may be adjusted such that the pair of restricting portions 522E are located outside the range of the conveyed material T.

The control apparatus 60 moves the hand section 52 such that the first pressers 522C are positioned on the − side of the conveyed material T in the Z direction and the second pressers 522D are positioned on the + side of the conveyed material T in the Z direction.

As shown in FIG. 5B, the control apparatus 60 performs control so as to narrow the distance between the first support portion 522A and the second support portion 522B and to hold the conveyed material T between the pair of the first pressers 522C and the second pressers 522D. A surface of the conveyed material on one side in the Z direction is pressed by the pair of first pressers 522C. A portion corresponding to a space between the pair of first pressers 522C on the surface of the conveyed material on the + side in the Z direction is pressed by the second presser 522D.

By being gripped by the pair of first pressers 522C and second presser 522D in this way, the conveyed material T is gripped in a curved state (see FIG. 4).

Being gripped in this way, the conveyed material T can be conveyed while maintaining a horizontal state when being horizontally conveyed.

For example, in the case of a configuration in which the conveyed material is gripped without being curved, such as a configuration in which the conveyed material can be gripped by two flat plate portions, the distal end portion of the conveyed material hangs down due to gravity during horizontal conveyance. Therefore, it is difficult to place the conveyed material on a bundle (printed material) placed at the conveyance destination.

In contrast, in the present embodiment, the conveyed material T can be conveyed while maintaining the conveyed material T in a horizontal state during horizontal conveyance. Further, since the conveyed material T is gripped by the gripper 522 in a curved state, the distal end portion of the conveyed material T does not hang down due to gravity. As a result, the distal end portion of the conveyed material T is easily aligned with a placement position at the conveyance destination, and thus the conveyed material T can be easily placed at the conveyance destination.

In addition, since the posture of the conveyed material T is restricted so that the pair of restricting portions 522E press both end portions of the conveyed material T from the outside of the pair of first pressers 522C, respectively, corrugation is applied to the conveyed material T, and the conveyed material T takes a horizontal posture in the width direction. As a result, since the posture of the conveyed material T can be stabilized during horizontal conveyance, the horizontal state of the conveyed material T can be more easily maintained during horizontal conveyance.

In addition, the control apparatus 60 releases the gripping by the gripper 522 when the conveyed material T conveyed by the hand section 52 is placed on the stacking apparatus 20 (a section of the post-processing device 30 where the printed material is supplied). In a case where the printed material P to be combined with the conveyed material T is disposed in the ejection section 12 of the image forming apparatus 10, the control apparatus 60 releases the gripping by the gripper 522 at a position corresponding to the top of the printed material P in accordance with the orientation of the printed material P. Specifically, for example, as illustrated in FIG. 2, when the long side of the printed material P is placed along the abutting section 21, the conveyed material T is placed so that the long side of the conveyed material T is along the abutting section 21.

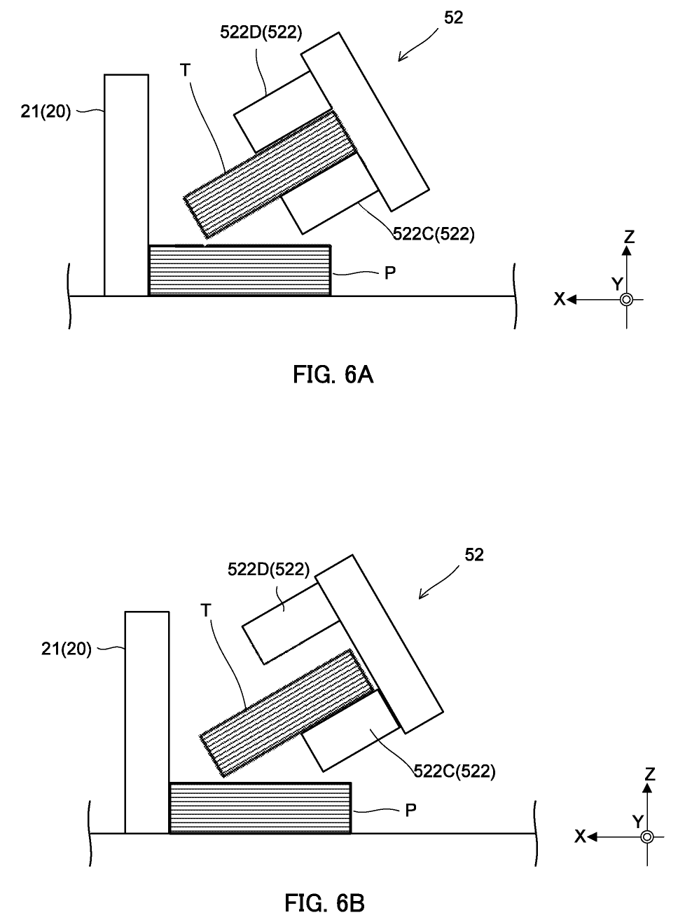

At this time, as shown in FIGS. 6A and 6B, the control apparatus 60 may control the posture of the gripper 522 such that the distal end portion of the conveyed material T is directed to the abutting section 21 and the conveyed material T is slid on the gripper 522. The posture of the gripper 522 in this case is, for example, a posture in which the gripper 522 is inclined with respect to the horizontal direction so that the distal end portion of the gripper 522 is located at the most − side position in the Z direction.

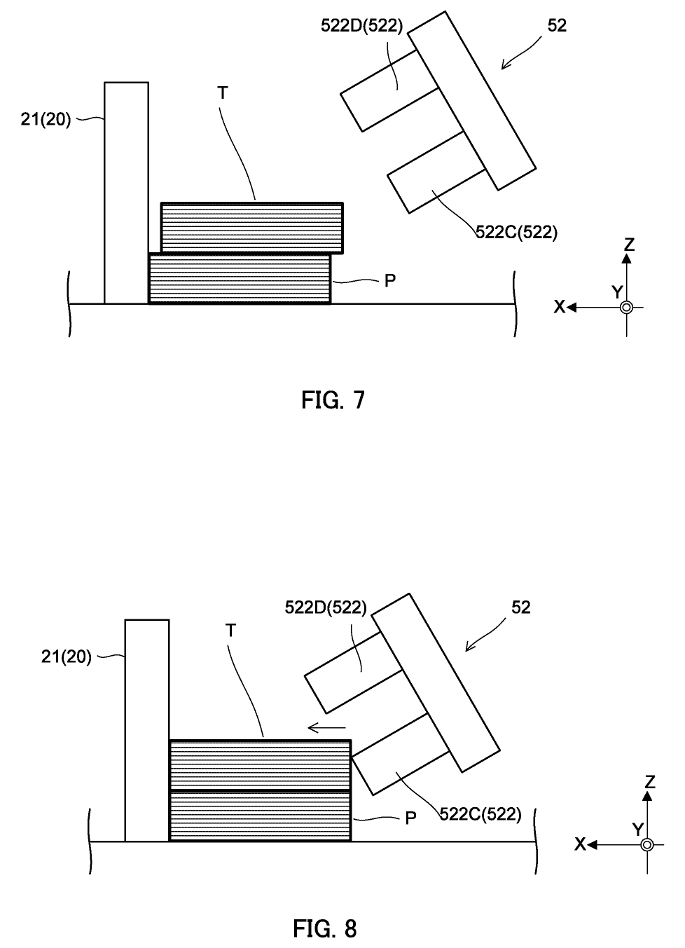

Thus, as illustrated in FIG. 7, the conveyed material T abuts against the abutting part 21, making it easier for the conveyed material to be placed at the placement position of the conveyed material T at the conveyance destination.

In addition, in the abutting operation, as illustrated in FIG. 8, the control apparatus 60 may perform control such that the conveyed material T is pressed toward the abutting section 21 by the gripper 522 after the conveyed material T is placed.

Thus, the conveyed material T can be positioned such that the distal end portion of the conveyed material T is located at a position contacting the abutting section 21.

Further, the placement surface for the conveyed material T may have a configuration capable of supporting both end portions of the sheet-shaped member, like the take-out section 41 of the loading apparatus 40. In this case, the control apparatus 60 controls the arm section 51 so that the hand section 52 moves both end portions of the conveyed material T to the positions of support portions while maintaining the horizontal state of the conveyed material T. Then, when both end portions of the conveyed material T reach the positions corresponding to the support portions, the control apparatus 60 releases the gripping of the gripper 522. Thus, the conveyed material T is placed.

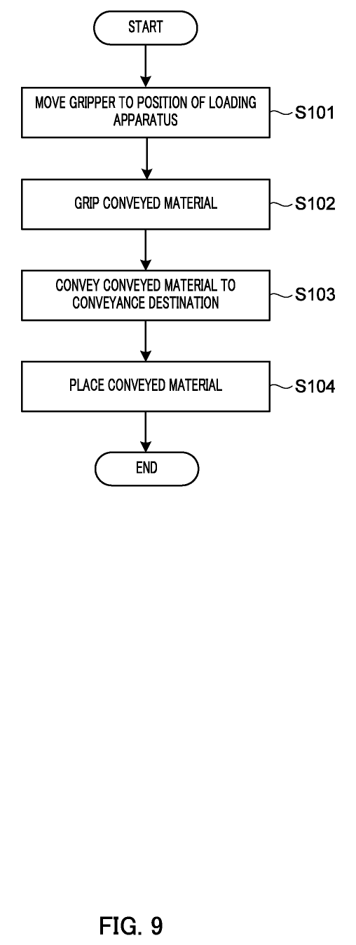

Next, a flow of conveyance processing by the robot apparatus 50 will be described. FIG. 9 is a flowchart illustrating an operation example of conveyance processing by the robot apparatus 50. The present control is appropriately executed when the robot apparatus 50 acquires a control signal from the control apparatus 60.

As shown in FIG. 9, the control apparatus 60 moves the gripper 522 to the position of the loading apparatus 40 (step S101). At this time, the control apparatus 60 adjusts the distance between the pair of first pressers 522C and the distance between the pair of restricting portions 522E while widening the distance between the first support portion 522A and the second support portion 522B.

After step S101, the control apparatus 60 controls the gripper 522 to grip the conveyed material T disposed on the take-out section 41 of the loading apparatus 40 (step S102). After step S102, the control apparatus 60 controls the arm section 51 to convey the conveyed material T to the conveyance destination (step S103).

After step S103, the control apparatus 60 releases the grip of the gripper 522 and places the conveyed material T (step S104). At this time, the control apparatus 60 may control the posture of the gripper 522 such that the conveyed material T slides on the gripper 522 toward the abutting section 21. Further, after placing the conveyed material T, the control apparatus 60 may perform control such that the conveyed material T is pressed toward the abutting section 21 by the gripper 522.

After step S104, the present control ends. Note that after step S104, when the conveyed material T exists in the loading apparatus 40 and there is an instruction to continue the conveyance process, the process returns to step S101 and the conveyance process is repeated again. Further, after step S104, processing by the post-processing device 30 may be executed.

In a case where the printed material P and the conveyance material T of the image forming apparatus 10 are combined, a process of executing a print job may be performed between step S101 and step S103. In this case, the process of step S104 is performed after the process by the print job is completed and the printed material P is placed at the position of the stacking apparatus 20 via the ejection section 12.

According to the present embodiment configured as described above, since the gripper 522 grips the conveyed material T so as to curve the conveyed material T, the conveyed material T can be conveyed while maintaining the conveyed material T in a horizontal state during horizontal conveyance. Furthermore, since the conveyed material T is gripped by the gripper 522 in a curved state, the distal end portion of the conveyed material T does not droop due to the gravity. As a result, the distal end portion of the conveyed material T is easily aligned with the placement position at the conveyance destination, and thus the conveyed material T can be easily placed at the conveyance destination.

That is, in the present embodiment, since it is possible to easily convey the conveyed material T using the robot apparatus 50, it is possible to automate the conveyance operation of the conveyed material T formed of a sheet-shaped member.

In addition, since the gripper 522 grips the conveyed material T by pressing the conveyed material T from both sides with the pair of first pressers 522C and the second presser 522D, the conveyed material T can be curved with a relatively simple configuration.

Incidentally, since a distal end portion of the conveyed material is likely to droop due to gravity during horizontal conveyance in the case of the configuration in which the conveyed material is sandwiched between the two flat plate portions, it is necessary to increase the size of a mechanism for gripping the conveyed material, such as increasing the size of the flat plate portions. Therefore, in the ejection section of the printing machine or the like which is not assumed to be approached by the robot apparatus, the robot apparatus or the gripper interferes with the machine such as the printing machine when the gripping of the conveyed material by the gripper and the release of the gripping are performed. As a result, an increase in the size of the entire system and an increase in cost may be incurred.

In contrast, in the present embodiment, since the conveyed material T is gripped so as to curve the conveyed material T with a simple configuration, horizontal conveyance can be easily realized with a compact configuration. As a result, it is possible to place the conveyed material T at the conveyance destination without the gripper 522 interfering with the machine at the conveyance destination, and thus it is possible to suppress an increase in size and cost of the entire system.

In addition, since the pair of first pressers 522C and second presser 522D are configured by the rod-shaped members, contact portions of the pair of first pressers 522C and second presser 522D making contact with the conveyed material are configured in a circular arc shape. For this reason, it is possible to suppress a mark or the like of the pressers from being formed at the contact portions of the conveyed material T.

In addition, since the posture of the conveyed material T is restricted such that the pair of restricting portions 522E press both end portions of the conveyed material T from the outside of the pair of first pressers 522C, respectively, the conveyed material T is corrugated. As a result, since the posture of the conveyed material T can be stabilized during horizontal conveyance, the horizontal state of the conveyed material T can be more easily maintained during horizontal conveyance.

Furthermore, since the pair of restriction sections 522E are formed of the rod-shaped members, the contact portions of the pair of restriction sections 522E with the conveyed material T are formed in a circular arc shape. For this reason, it is possible to suppress a mark or the like of the restricting portion 522E from being left on the contact portions of the conveyed material T.

In addition, the pair of first pressers 522C are configured such that the distance between the pair of first pressers 522C can be adjusted, and the distance between the pair of first pressers 522C and the second presser 522D can be adjusted. That is, the gripper 522 can adjust the degree of bending of the conveyed material T to be applied by the pair of first pressers 522C and the second presser 522D.

For example, the control apparatus 60 may adjust the amount of biting of the second presser 522D into the pair of first pressers 522C (the distance between the pair of first pressers 522C and the second presser 522D in the Z direction). Specifically, the control apparatus 60 may perform adjustment such that the biting amount decreases as the thickness of the conveyed material T increases.

Further, for example, the control apparatus 60 may adjust the distance (distance in the width direction) between the pair of first pressers 522C in accordance with the rigidity of the sheet-shaped member constituting the conveyed material T. When the curvature is made steep in a case where the rigidity of the sheet-shaped member is high, the sheet-shaped member tends to take a permanent set, whereas when the rigidity of the sheet-shaped member is low, the sheet-shaped member is less likely to take a permanent set. Since the curvature becomes steeper as the distance between the pair of first pressers 522C becomes narrower, the control apparatus 60 may make an adjustment so as to widen the above-described distance as the rigidity of the sheet-shaped member becomes higher.

More specifically, for example, it is assumed that the thickness of the conveyed material T is relatively large, and the sheet-shaped member constituting the conveyed material T is a member having high rigidity such as thick paper. In this case, for example, the control apparatus 60 adjusts the degree of bending so as to reduce the amount of biting of the second presser 522D into the pair of first pressers 522C. In addition, the control apparatus 60 adjusts the degree of bending so as to widen the distance between the pair of first pressers 522C since it is necessary to make the bending gentle since the thick paper tends to take a permanent set.

In addition, it is assumed that the thickness of the conveyed material T is relatively small and the sheet-shaped member constituting the conveyed material T is a member having high rigidity. In this case, for example, the control apparatus 60 adjusts the degree of bending so as to increase the amount of biting of the second presser 522D into the pair of first pressers 522C. In addition, the control apparatus 60 adjusts the degree of bending so as to widen the distance between the pair of first pressers 522C in consideration of the fact that the thick paper tends to take a permanent set.

Further, it is assumed that the thickness of the conveyed material is relatively large, and the sheet-shaped member constituting the conveyed material T is a member having low rigidity such as thin paper. In this case, for example, the control apparatus 60 adjusts the degree of bending so as to reduce the amount of biting of the second presser 522D into the pair of first pressers 522C. In addition, since the thin sheet is less likely to take a permanent set and there is no problem even if the curve is made steep, the control apparatus 60 adjusts the degree of the curve so as to narrow the distance between the pair of first pressers 522C.

Further, it is assumed that the thickness of the conveyed material T is relatively small, and the sheet-shaped member constituting the conveyed material T is a member having low rigidity such as thin paper. In this case, for example, the control apparatus 60 adjusts the degree of bending so as to increase the amount of biting of the second presser 522D into the pair of first pressers 522C. In addition, the control apparatus 60 adjusts the degree of bending so as to narrow the distance between the pair of first pressers 522C in consideration of the fact that the thin paper is less likely to take a permanent set.

Furthermore, the control apparatus 60 may adjust the degree of curving of the conveyed material R according to the surface properties of the conveyed material R. For example, in a case where the sheet-shaped member constituting the conveyed material T is made of a material whose surface is likely to be flawed, the surface of the sheet-shaped member is likely to be flawed when the curvature is made steep or the amount of biting is increased. Therefore, in this case, the control apparatus 60 adjusts the degree of bending so as to reduce the amount of biting of the second presser 522D into the pair of first pressers 522C and to increase the distance between the pair of first pressers 522C.

The control apparatus 60 may also adjust the degree of curving of the conveyed material T according to the length of the conveyed material T. The length of the conveyed material T is the length from the end portion on the side gripped by the gripper 522 to the end portion (distal end portion) on the side not gripped by the gripper 522. When the length of the conveyed material T is long, the distal end portion tends to droop due to gravity. Therefore, in this case, the control apparatus 60 adjusts the degree of bending by at least one of increasing the amount of biting of the second presser 522D into the pair of first pressers 522C and narrowing the distance between the pair of first pressers 522C.

Further, the control apparatus 60 may adjust the degree of bending of the conveyed material T according to the width of the conveyed material T. Since a range that can be gripped by the gripper 522 varies depending on the widths of the conveyed material T, it is necessary to adjust the distance between the pair of first pressers 522C to the widths of the conveyed material in consideration of stabilization of the gripping. In this case, since there is a possibility that the required bending amount cannot be obtained, the required bending amount may be secured by adjusting the biting amount of the second presser 522D with respect to the pair of first pressers 522C.

In this way, by adjusting the degree of bending of the conveyed material T imparted by the pair of first pressers 522C and the second presser 522D, the gripping method can be changed in accordance with various situations. As a result, the conveyed material T can be conveyed by an optimal conveyance method in accordance with the situation.

In the above embodiment, each of the pair of first pressers 522C is configured as a separate body. However, the present invention is not limited thereto, and the pair of first pressers may be integrally configured.

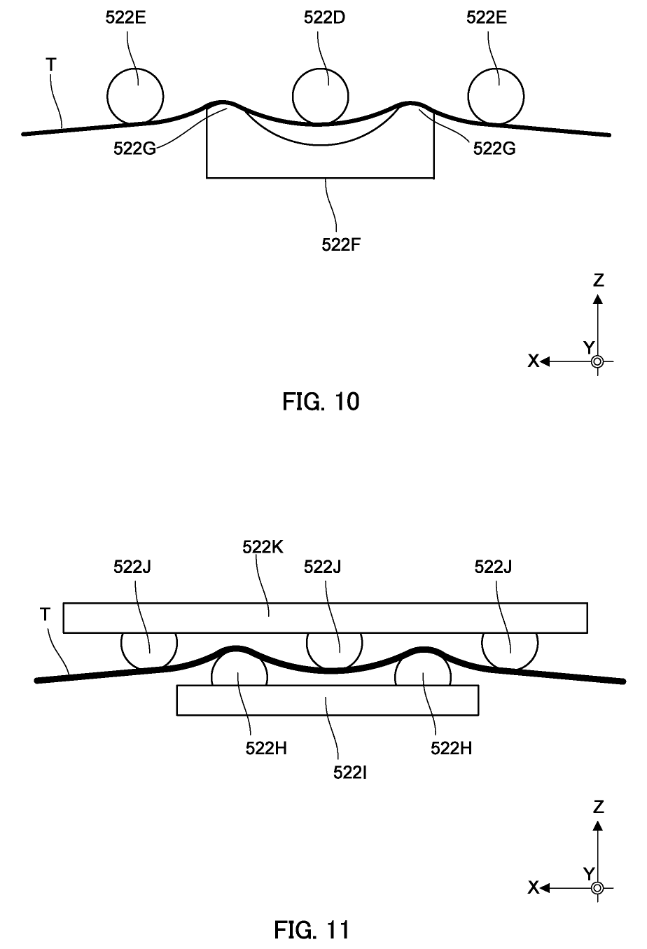

To be specific, the configuration shown in FIG. 10 has a facing portion 522F instead of the pair of first pressers of the above-described embodiment. The facing portion 522F is disposed at a position facing the second presser 522D in the Z-direction. The facing portion 522F is configured to sandwich the conveyed material with the second presser 522D when the second presser 522D presses the conveyed material T.

In addition, a pair of protruding portions 522G are provided on the facing portion 522F outside the second presser 522D. The pair of projecting portions 522G press portions of the conveyed material T corresponding to both sides in the width direction of the portion pressed by the second presser 522D. The pair of projecting portions 522G is a feature that corresponds to the "pair of first pressers" according to the present invention.

In addition, by providing the pair of protruding portions 522G, the facing portion 522F forms a recessed portion that is recessed to the − side in the Z direction. That is, the portion between the pair of protruding portions 522G forms a recessed portion into which the second presser 522D can enter when the gripper 522 grips the conveyed material.

Further, the contact portion of the second presser 522D with the conveyed material T and the portion of the recessed portion are formed in a circular arc shape.

Thus, it is possible to prevent marks caused by contact of the conveyed material T with the base end portions of the pair of protruding portions 522G of the facing portion 522F.

Further, in the above-described embodiment, the respective contact portions of the pair of first pressers 522C and the second presser 522D are configured in a circular arc shape. However, the present invention is not limited thereto, and the contact portions may not be configured in a circular arc shape, and may be a quadrangular prism-shaped member.

In the above-described embodiment, at least the second presser 522D is formed of a rod-shaped member, but the present invention is not limited thereto. For example, as shown in FIG. 11, a configuration may be adopted in which the conveyed material T can be sandwiched between a first plate-shaped member 522I provided with a pair of convex portions 522H (first presser) and a second plate-shaped member 522K provided with convex portions 522J (second presser). Further, in the configuration shown in FIG. 11, the second plate-shaped member 522K is provided with a total of three convex portions 522J, one at a position between the pair of convex portions 522H, and one on each of both sides of the pair of convex portions 522H. Of the three convex portions 522J, the convex portion 522J located in the middle corresponds to the "second presser" according to the present invention, and the other convex portions 522J correspond to the "pair of restricting portions" according to the present invention.

Furthermore, in the embodiment described above, the first pressers 522C and the second presser 522D are formed of the same member. Therefore, the friction coefficients of the first pressers 522C and the second presser 522D are also the same, but the present invention is not limited thereto. For example, of the pair of the first pressers 522C and the second presser 522D, the friction coefficient of the first pressers 522C located on the placement surface side at the conveyance destination of the conveyed material T may be smaller than the friction coefficient of the second presser 522D located on the side opposite to the placement surface side.

When the conveyed material T is disposed, the conveyed material T is slid on the gripper 522, that is, on the presser (first presser 522C) on the − side in the Z direction. Therefore, by making the coefficient of friction of the first presser 522C relatively small, it is possible to make it easy to smoothly place the conveyed material T on the placement surface.

Further, in the above-described embodiment, the length of the gripper 522 from the base section 521 to the distal end portion of the gripper 522 is constant, but the present invention is not limited thereto, and the gripper may be configured such that the length can be adjusted.

Examples of the configuration for adjusting the length of the gripper include a configuration in which a portion of the gripper can be expanded and contracted, and a configuration in which a plurality of grippers having different lengths are provided and a gripper to be used for gripping can be switched among the plurality of grippers.

Specifically, the gripper may be adjusted such that the length falls within a predetermined range. The predetermined range is a range from 1/3 of the length of the conveyed material to the length of the conveyed material. In other words, the gripper is adjusted to increase the length of the gripper when the length of the conveyance is long, and to decrease the length of the gripper when the length of the conveyance is short.

Thus, conveyed materials having any length can be stably gripped.

Furthermore, the size of the gripper may be adjustable.

As a configuration for adjusting the size of the gripper, for example, there is a configuration in which a plurality of grippers having different sizes (the size of the diameter of the rod-shaped member or the like) are provided and a gripper to be used for gripping can be switched from the plurality of grippers.

Accordingly, the degree of bending can be adjusted by changing the size of the gripper.

Further, in the above-described embodiment, the robot apparatus grips the conveyed material at the take-out section of the loading apparatus. Specifically, the robot apparatus grips the long side portion of the conveyed material, but the present invention is not limited thereto, and the robot apparatus may grip the short side portion of the conveyed material. Further, under the control of the control apparatus 60, the robot apparatus may select the gripped portion of the conveyed material in accordance with the placement mode of the conveyed material at the conveyance destination.

For example, in a case of a configuration in which a long side portion of the sheet-shaped member is abutted against the abutting section in the ejection section that is the conveyance destination, the long side portion of the conveyed material is set as the gripped portion, and in a case of a configuration in which a short side portion of the sheet-shaped member is abutted against the abutting section, the short side portion of the conveyed material is set as the gripped portion.

In this way, when the conveyed material is conveyed to the conveyance destination, the conveyed material can be easily placed.

Further, in the above-described embodiment, the predetermined conveyance destination is the sheet feed section of the post-processing device 30 (the supply portion of the printing machine), but the present invention is not limited thereto. The predetermined conveyance destination may be, for example, a sheet feed section of the image forming apparatus. For example, assume a case where additional printing is performed in the image forming apparatus. In this case, the robot apparatus grips the bundle of the printed material ejected from the image forming apparatus by the gripper, and conveys the bundle to the sheet feed section again. Thus, the step of additional printing can be automated.

Further, the predetermined conveyance destination may be, for example, a loading section (loading apparatus) of the sheet-shaped member. For example, assume that a bundle of printed material ejected from the image forming apparatus is conveyed to the loading apparatus in advance when merging it with a bundle of printed material of another image forming apparatus. In this case, the robot apparatus grips the bundle of printed material ejected from the image forming apparatus by the gripper and conveys the bundle to the loading apparatus. This makes it possible to automate the step of loading a printed material on the loading apparatus.

Furthermore, although the pair of restricting portions are provided in the above-described embodiment, the present invention is not limited to this, and the pair of restricting portions may not be provided.

Further, in the above-described embodiment, the configuration is adopted in which the conveyed material is placed on the printed material output from the image forming apparatus, that is, one or more sheet-shaped members which are not processed by the post-processing device, but the present invention is not limited thereto. For example, the printed material may be a processed booklet such as a saddle stitch booklet, a center-folded booklet, a wireless-bound booklet, or a side-stitched booklet.

Furthermore, in the above embodiment, the combination system includes one robot apparatus, but the present invention is not limited thereto, and the combination system may include two or more robot apparatuses. In this case, the two or more robot apparatuses are different from each other in the length of the gripper, the size of the gripper, and the like, and one of the two or more robot apparatuses may be selected according to the length of the gripper, the size of the gripper, and the like to be used. Furthermore, a configuration may be adopted in which a combined material obtained by combining conveyed materials that have been conveyed by a predetermined robot apparatus is conveyed by another robot apparatus and combined with a printed material.

In addition, each of the above-described embodiments is merely an example for embodying the present invention, and the technical scope of the present invention should not be interpreted in a limited manner by these embodiments. That is, the present invention can be implemented in various forms without departing from the spirit or main features thereof.

Although embodiments of the present invention have been described and illustrated in detail, the disclosed embodiments are made for purposes of illustration and example only and not limitation. The scope of the present invention should be interpreted by terms of the appended claims.

What is claimed is:

1. A gripping device for gripping a conveyed material including one or more sheet-shaped members, the gripping device comprising:
a base section; and
a gripper disposed on the base section and capable of gripping the conveyed material so as to curve the conveyed material.

2. The gripping device according to claim 1, wherein
the gripper includes a pair of first pressers capable of pressing the conveyed material from one side in a gripping direction of the conveyed material, and a second presser capable of pressing a portion of the conveyed material corresponding to a space between the pair of first pressers from the other side in the gripping direction.

3. The gripping device according to claim 2, wherein
the gripper bends the conveyed material such that a portion of the conveyed material pressed by the second presser is located on the one side with respect to a contact portion between the first presser and the conveyed material.

4. The gripping device according to claim 2, wherein
the pair of first pressers and the second presser are configured to extend from the base section.

5. The gripping device according to claim 4, wherein
the pair of first pressers and the second presser are formed from a rod-shaped member.

6. The gripping device according to claim 5, wherein
contact portions of the pair of first pressers and the second presser making contact with the conveyed material are configured in a circular arc shape.

7. The gripping device according to claim 2, wherein:
the pair of first pressers are integrally formed, and
a portion between the pair of first pressers constitutes a recessed portion into which the second presser can enter when the gripper grips the conveyed material

8. The gripping device according to claim 7, wherein
a contact portion of the second presser making contact with the conveyed material and a portion of the recessed portion are configured in a circular arc shape.

9. The gripping device according to claim 2, wherein
the gripper includes a pair of restricting portions disposed so as to sandwich the second presser and capable of restricting a posture of the conveyed material by supporting, from the other side in the gripping direction, a portion of the conveyed material outside a pressed portion pressed by the pair of first pressers.

10. The gripping device according to claim 9, wherein
contact portions of the pair of restricting portions making contact with the conveyed material are configured in a circular arc shape.

11. The gripping device according to claim 1, wherein
the gripper is configured to be capable of adjusting a degree of curvature of the conveyed material.

12. The gripping device according to claim 1, wherein
the gripper is configured such that a length from the base section to a distal end portion of the gripper is adjustable

13. The gripping device according to claim 9, wherein
the pair of restricting portions are configured such that a distance therebetween is adjustable.

14. The gripping device according to claim 2, wherein
a friction coefficient of a presser of the pair of first pressers and the second presser which is positioned on a placement surface side at a conveyance destination of the conveyed material is smaller than a friction coefficient of a presser of the pair of first pressers and the second presser which is positioned on a side opposite to the placement surface side.

15. A conveying method performed by a gripping device including a base section and a gripper disposed on the base section and capable of gripping a conveyed material composed of one or more sheet-shaped members, the conveying method comprising:
gripping the conveyed material by the gripper; and
conveying the conveyed material gripped by the gripper, wherein
the gripping includes gripping the conveyed material by the gripper so as to curve the conveyed material.

16. The conveying method according to claim 15, wherein
the gripping includes selecting a gripped portion of the conveyed material in accordance with a placement mode of the conveyed material at a conveyance destination.

17. The conveying method according to claim 15, further comprising:
placing the conveyed material, which has been conveyed, on a printed material such that an orientation of the conveyed material matches an orientation of the printed material, the printed material being constituted by one or more other sheet-shaped members.

18. The conveying method according to claim 15, further comprising:
a conveyance destination of the conveyed material is a sheet feed section of a printing machine, a supply section of a print processing machine, or a loading section of a sheet-shaped member, which is disposed at a position different from a place where the conveyed material is gripped.

19. The conveying method according to claim 17, wherein
the placing includes:
releasing the gripping of the gripper and sliding the conveyed material on the gripper toward an abutting section provided at a conveyance destination of the conveyed material, and
abutting the conveyed material against the abutting section in order to place the conveyed material at the conveyance destination.

20. The conveyance method according to claim 19, wherein
the placing includes pressing the conveyed material toward the abutting section by the gripper after the conveyed material is placed during the abutting.
